(19) United States
(12) Patent Application Publication
(10) Pub. No.: US 2023/0192463 A1
(43) Pub. Date: Jun. 22, 2023

(54) VEHICLE TO COLLECT AND TRANSPORT FLAT ARTICLES, SYSTEM AND METHOD TO HANDLE FLAT ARTICLES

(71) Applicant: SACMI TECH S.P.A., IMOLA (IT)

(72) Inventor: Maurizio BARDI, FORMIGINE (IT)

(21) Appl. No.: 18/000,217

(22) PCT Filed: May 28, 2021
(86) PCT No.: PCT/IB2021/054707

§ 371 Date: Nov. 29, 2022

(30) Foreign Application Priority Data
May 29, 2020 (IT) 102020000012850

(51) Int. Cl. B66F 9/18; B66F 9/075; B66F 9/20; B25J 18/02; B25J 9/16

(52) U.S. Cl. CPC B66F 9/181; B66F 9/07568; B66F 9/07572; B66F 9/0755; B66F 9/20; B25J 18/025; B25J 9/162

(57) ABSTRACT

A vehicle to collect and transport flat articles; the vehicle being configured to transport at least 500 kg; the vehicle comprises a frame having at least one support device, which is configured to receive a plurality of flat articles; a first moving device, which is configured to move said vehicle; at least one holding device, which is configured to hold, grab and release at least one flat ceramic article; and a moving assembly to move at least one of either the holding device or said support device relative to the other one along at least one moving trajectory, which is at least partially vertical.

### CROSS-REFERENCE TO RELATED APPLICATIONS

This patent application claims priority from Italian patent application no. 102020000012850 filed on 29 May 2020, the entire disclosure of which is incorporated herein by reference.

### TECHNICAL FIELD

The present invention relates to a vehicle to collect and transport flat articles, to a system and to a method to handle flat articles.

### BACKGROUND OF THE INVENTION

The known systems for handling flat ceramic articles provide for the flat ceramic articles coming out of a production line to be stored in suitable storing structures, wherefrom, for each order, a certain number of flat ceramic articles of a certain type is picked up, possibly packaged, and finally sent.

Specifically, the flat ceramic articles of the same type, for example of the same color, of the same size, having analogous surface characteristics etc., are organized in groups, generally arranged in suitable containers, and each set within a given housing of the storing structure. When an order of flat ceramic articles to be sent has to be prepared, a holding vehicle, driven automatically or manually, picks up from the storing structure the container containing the group of articles of the type requested, transports it to a picking area (also called “picking bay”), where an operator, or a suitable robot (or other devices suited to the purpose), picks up from the container the number of articles that has to be sent and sets them within a sending unit, for example in a box, or in a stand, or in a plank etc.; immediately after, the vehicle transfers the container again into its housing, if such container still contains flat ceramic articles, or to an empty deposit area.

Therefore, the forming of an order of flat ceramic articles to be sent requires a certain time, a certain number of holding vehicles, driven manually or automatically, and a certain number of operators and/or of robots that carry out the actual picking.

The problem of the time and of the means necessary for forming an order to be sent is particularly felt for the so-called mixed orders, i.e. the orders containing flat ceramic articles of different type. In these cases, in fact, in order to create the mixed order to be sent, a holding vehicle, driven automatically or manually, picks up from the storing structure a first container containing the group of articles of the first type requested, transports it to a picking area (also called “picking bay”), where an operator, or a suitable robot, picks up from such container a certain number of articles of such first type and transfers the articles in a sending unit, at this point (once the requested number of flat articles of the first type has been picked up) the vehicle transfers the first container again into its housing, or to an accumulation area of empty containers and picks up a second container containing a group of articles of a second type from the storing structures, transports it to the picking area, where the operator, or the suitable robot, picks up from such second container a certain number of flat ceramic articles of such second type, and transfers them in the same sending unit; immediately after, the vehicle transfers the second container again into its housing, if it still contains flat articles, or to an empty deposit area. Such operations are repeated as many times as is the number of types of flat ceramic articles which constitute a single mixed order to be sent, with a consequent increase in the time necessary for forming an order, and/or in the waiting time in the picking area, and/or in the number of vehicles necessary for forming an order to be sent, etc.

The object of the present invention is to provide a vehicle for collecting and transporting flat articles, a system and a method for handling flat articles, which allow overcoming, at least partially, the drawbacks of the prior art and are, simultaneously, easy and cost-effective to produce.

### SUMMARY

In accordance with the present invention, a vehicle for collecting and transporting flat articles, a system and a method for handling flat articles are provided, according to what is claimed in the appended independent claims, and preferably, in any one of the claims directly or indirectly dependent on the mentioned independent claims.

The claims describe preferred embodiments of the present invention forming integral part of the present description.

### BRIEF DESCRIPTION OF THE DRAWINGS

The invention is described in the following with reference to the accompanying drawings, which illustrate some non-limiting embodiment examples thereof, wherein:

FIG. 1 is a perspective view of a vehicle for collecting and transporting flat articles in accordance with a first embodiment of the present invention;

FIG. 2 is a side view of the vehicle of FIG. 1;

FIGS. 3 and 4 illustrate two side views of the vehicle of FIGS. 1 and 2 during two subsequent operations of the vehicle, i.e. the raising of a holding device and the picking up of a flat article;

FIG. 5 is a perspective view of the vehicle of FIG. 4;

FIGS. 6 and 7 illustrate two perspective views of the vehicle of FIGS. 1-5, during, respectively, a holding operation of a flat article from a stand situated next to the vehicle and a transfer operation of the flat article on a support structure;

FIGS. 8 and 9 illustrate two views analogous to views 6 and 7, wherein the flat article is picked up from a stand situated in front of the vehicle and is transferred on a support structure;

FIGS. 10 and 11 illustrate two perspective views of the vehicle of FIGS. 1-9, during two subsequent operations, respectively, the holding of a flat article from a stand and the transfer of the flat article on a support structure;

FIGS. 12 and 13 illustrate two perspective views analogous to FIGS. 10 and 11, wherein the flat article, after being picked up, is transferred on a support structure arranged in a position, relative to the vehicle, different from the one illustrated in FIGS. 10 and 11;

FIGS. 14, 15 and 16 illustrate, respectively, a perspective view, a side view and a bottom view of a different embodiment of the vehicle of the preceding figures while it places a flat article on a further support structure;

FIGS. 17, 18 and 19 illustrate an enlarged scale of the details of the holding device of the vehicle of FIGS. 1-16,

FIGS. 20, 21, and 22, illustrate three perspective views of a vehicle in accordance with a further embodiment of the present invention during, respectively, the picking up of a flat article from a stand, the moving of the flat article, and the transfer of the flat article on a support structure.

### DETAILED DESCRIPTION

In the accompanying figures, reference numeral 1 indicates, as a whole, a vehicle 1 for collecting and transporting flat articles 2. Advantageously but not necessarily, such flat articles 2 are articles 2 of the ceramic processing industry such as, for example, ceramic slabs and/or tiles.

According to some advantageous but non-limiting embodiments, the vehicle 1 is configured to operate within a system 3 for handling flat articles 2 (only partially illustrated in FIGS. from 6 to 16) which comprises: at least one storing structure 4 having a plurality of housings 5, each configured to contain (and in particular, containing) therein a given type (i.e. having given aesthetic and/or physical and/or functional characteristics) of flat articles 2; a picking area (not illustrated) for receiving a group of flat articles 2 to be sent; and a work area (not illustrated), which extends from the storing structure 4 (in particular, from the storing structures 4) to the picking area and within which at least one vehicle 1 operates, preferably a plurality of vehicles 1. In particular, the system 3 for handling flat articles 2 comprises at least one vehicle 1 (more in particular, a plurality of vehicles 1, each) configured (adapted) to operate within the work area for picking up a plurality of flat articles 2, each, from a respective housing 5 of the support structure 4 and transport it to the picking area.

According to some advantageous but non-limiting embodiments (such as the ones illustrated in FIGS. from 6 to 16), the (each) storing structure 4 comprises (in particular, consists of) a plurality of support elements, such as stands (as illustrated in FIGS. from 6 to 16), or containers, etc., each configured to contain a plurality of flat articles 2 of a certain type. Specifically, according to some advantageous but non-limiting embodiments (such as the ones illustrated in FIGS. from 6 to 16), each stand 4 comprises two housings 5, one on each side, configured to each receive a plurality of flat articles 2. Alternatively or in combination, according to some advantageous but non-limiting embodiments not illustrated, the storing structure 4 comprises (in particular, is) a shelving with uprights, beams and crosspieces possibly having a covering shelf, or a structure with uprights and side shelves, or a cantilever shelving etc.

According to some advantageous embodiments (such as the ones illustrated in the accompanying figures), the vehicle 1 comprises a frame 6 having at least one support device 7 configured to receive a plurality of flat articles 2. Advantageously but not necessarily, the vehicle 1, in particular the support device 7, is configured (in particular, is sized) to (receive and) transport at least 500 kg (of flat ceramic articles), in particular at least 1000 kg (of flat ceramic articles), more in particular at least 1500 kg (of flat ceramic articles).

Advantageously but not necessarily, the vehicle 1 is configured to pick up a plurality of flat articles 2, each, from a respective housing 5 of one of the storing structures 4 and to release it onto the support device 7 in order to create a group of flat articles 2 to be sent, and to bring the group of flat articles 2 to be sent to the picking area. In particular, the vehicle 1 can pick up from a same housing 5 more flat articles 2, based on the type of group of flat articles 2 to be sent, i.e. based on the number of flat articles 2 of each type requested. Typically but not necessarily, the vehicle 1 is configured to pick up flat articles 2 (of different type) from different housings 5.

In accordance with some advantageous embodiments, the vehicle 1 further comprises a moving device 8 configured to move the vehicle 1 within the work area.

Advantageously but not necessarily, the vehicle 1 is a vehicle 1 driven automatically configured to operate within a properly equipped work area. In this case, advantageously but not limitedly, the vehicle 1, in particular the moving device 8, comprises a localization system 9 configured to localize and/or receive information on the position of the vehicle 1 within the work area; and a control unit 10 configured to operate the moving device 8 so as to move the vehicle 1 within the work area based on what is detected and/or received by the localization system 9.

Specifically, according to some advantageous but non-limiting embodiments such as the ones illustrated in the accompanying figures, the localization system 9 is of the laser type and comprises at least one laser emitter, preferably but not necessarily rotating, configured to emit a laser beam within the work area surrounding the vehicle 1, equipped with reflecting elements (not illustrated), and at least one optical reading member configured to detect the direction of the laser beam reflected by such reflecting elements, so as to detect the position of the vehicle 1 within the work area. Such solution allows, advantageously, a precise localization of the vehicle 1 driven automatically, without invasive interventions within the work area of the system 3 for handling flat articles 2, since it is sufficient to put a plurality of reflecting elements within the work area wherein the vehicle 1 is intended to move.

Alternatively, the localization system 9 of the vehicle 1 driven automatically can be of inertial type, or a satellite navigation system by means of GPS, or of magnetic type by means of magnets situated on the floor, or it can comprise a plurality of video cameras and a control device for reading the images captured by the video cameras and creating a three-dimensional map of the space.

According to some advantageous but non-limiting embodiments, the picking area comprises a plurality of sending structures (not illustrated and known per se), configured to receive a group of flat articles 2 to be sent, for example the sending structures can be planks, cases, stands, trays, boxes, etc. In this case, advantageously but not necessarily, the control unit 10 is configured to operate the vehicle 1 for picking up the plurality of articles 2 in order to form the group of flat articles 2 to be sent and (once formed the group of articles 2 to be sent) to determine the movement of the vehicle 1 in order to transfer the group of articles 2 to be sent to the picking area, where the same vehicle 1, or another vehicle/robot or an operator, transfers the group of articles 2 to be sent on the sending structures.

Advantageously but not necessarily, the vehicle 1 comprises at least one holding device 11 configured to hold (in particular, to grab) and release at least one flat article 2. According to some advantageous embodiments such as the ones illustrated, the holding device 11 is configured to hold and release at least one flat article 2, in particular at least one flat ceramic slab, even more in particular a flat ceramic slab having dimensions equal to (at least) about 1200×2400 cm; in particular to (at least) about 1600×3200 cm; even more in particular to (at least) about 1800×3600 cm.

According to some advantageous but non-limiting embodiments such as the ones illustrated in the accompanying figures, the vehicle 1 further comprises a moving assembly 12 for moving, in particular getting close to and/or moving away from, at least one of either the holding device 11 or the support device 7 relative to the other one, along at least one moving trajectory, which is at least partially vertical (i.e. substantially vertical or oblique but having at least one vertical component). Such trajectory is further, advantageously but not necessarily, (also) at least partially horizontal, i.e. either substantially horizontal or oblique but having at least one horizontal component.

The vehicle 1 can thus pick up a flat article 2 from a housing 5, release it onto the support device 7 and immediately after, in particular without substantially moving away from the support structure 4 (and in any case without having to first transfer to another device the flat article 2 just picked up), pick up another flat article 2 from the same housing 5, or from another housing 5, and release it onto the support device 7. In other words, advantageously, the vehicle 1 allows creating (assemblying/organizing) the group of flat articles 2 to be sent directly on the support device 7, picking up the articles 2 and grouping them on the support device 7 and only afterwards (once the group to be sent has been formed—or at least partially formed) go back to the picking area, where such group is sent directly (as formed by the vehicle 1) or is transferred on a suitable sending structure from which it is sent.

Furthermore, advantageously but not necessarily, the moving assembly 12 comprises a moving device 13 for at least partially vertically moving the support device 7, i.e. along a substantially vertical trajectory, for example according to some non-limiting embodiments (such as the one illustrated in FIGS. from 1 to 16) running along a pair of vertical guides 14, or moving along an oblique path having at least one vertical component.

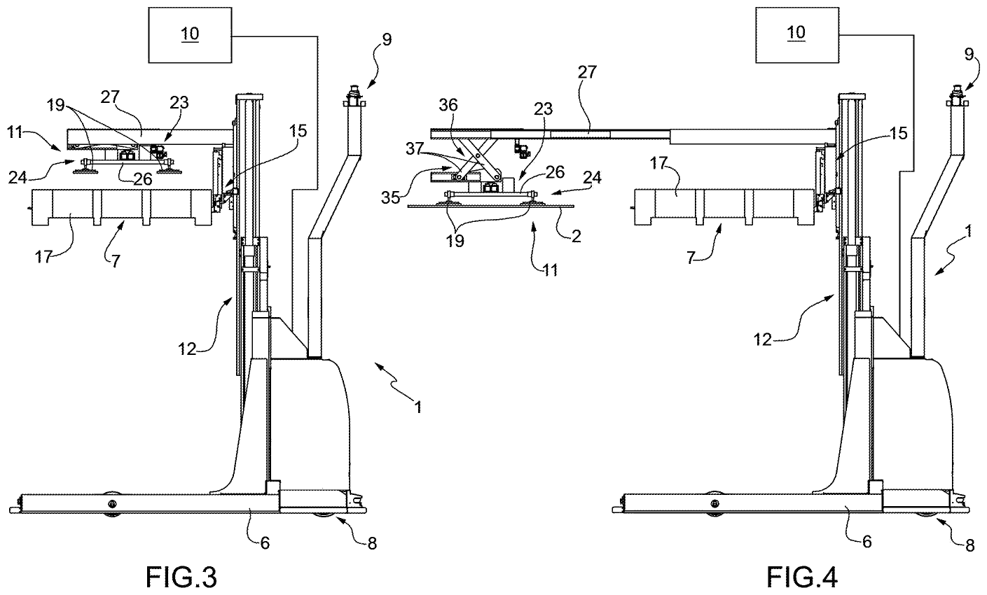

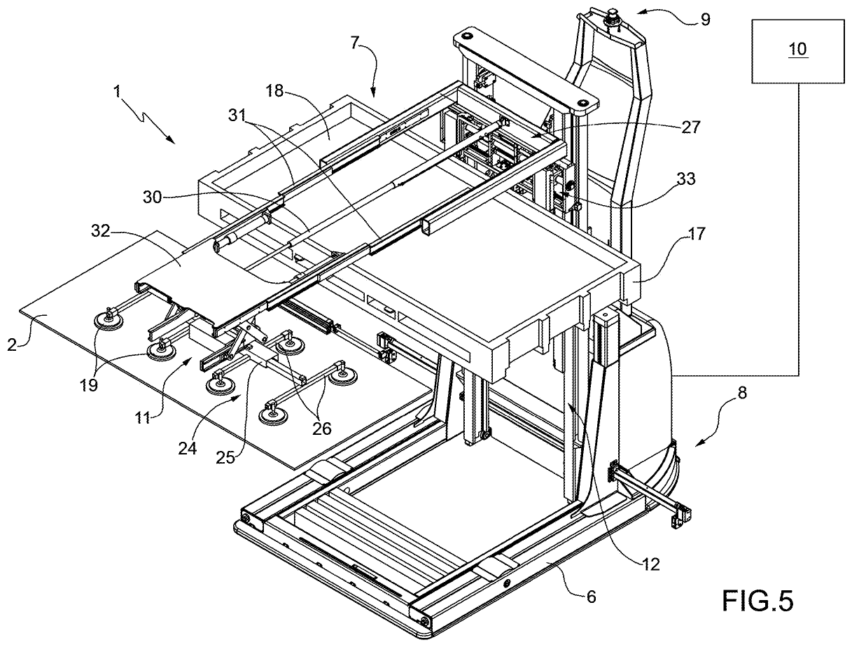

According to some advantageous but non-limiting embodiments such as the ones illustrated in FIGS. from 1 to 5, the vehicle 1 is configured in such a way that the support device 7 follows the holding device 11 when the latter picks up a flat article 2 (see for example FIG. 3). Specifically, advantageously but not necessarily, the moving device 13 is configured to move the support device 7 so that the latter is arranged (during every pick-up operation of a flat article 2) right under the holding device 11, so as to minimize the path that the holding device 11 has to carry out for releasing the flat article 2 onto the support device 7. This allows reducing the time necessary for creating a group of flat articles 2 to be sent, minimizing the path (and thus the time) that the holding device 11 has to carry out from the housing 5 from where it picks up the flat article 2 to the support device 7 where it releases it.

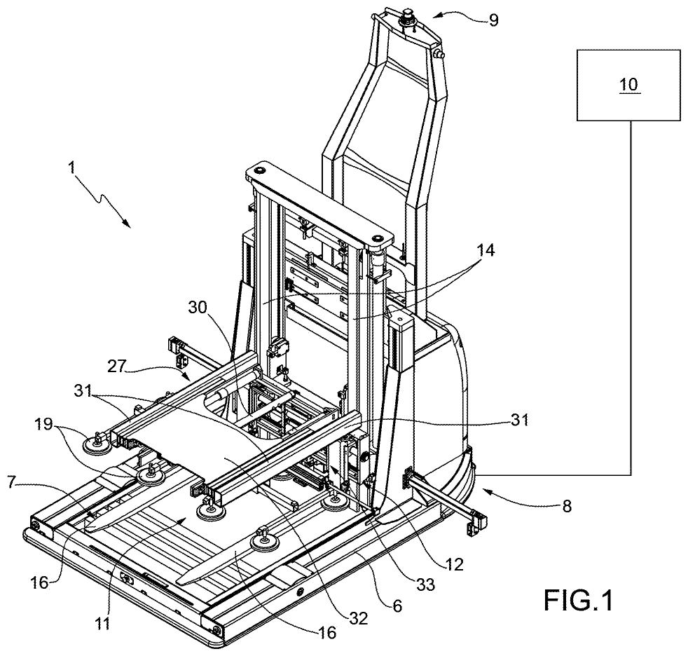

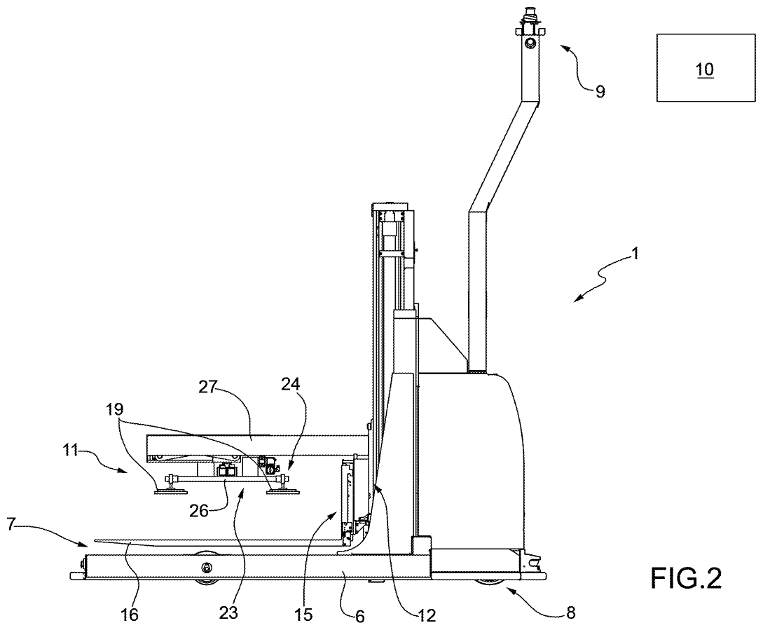

In this case, according to some advantageous but non-limiting embodiments (see for example FIGS. from 1 to 5), the support device 7 comprises a carriage 15 which is movable along a pair of vertical guides 14 fixed to the frame 6. Advantageously but not necessarily, such carriage 15 carries in a cantilever manner a pair of forks 16 (see FIG. 1), and the moving device 13 comprises (in particular, consists of) a motor or an actuator for moving such carriage 15 along the pair of vertical guides 14 so as to lower or raise the support device 7, in particular the forks 16.

Alternatively, according to other non-limiting embodiments (see FIGS. from 6 to 16), the support device 7 remains in a fixed position, for example at the bottom as in FIGS. from 6 to 16. In this case, advantageously but not necessarily, the holding device 11 after picking up the flat article 2 moves along an at least partially vertical trajectory for releasing the article 2 onto the support device 7.

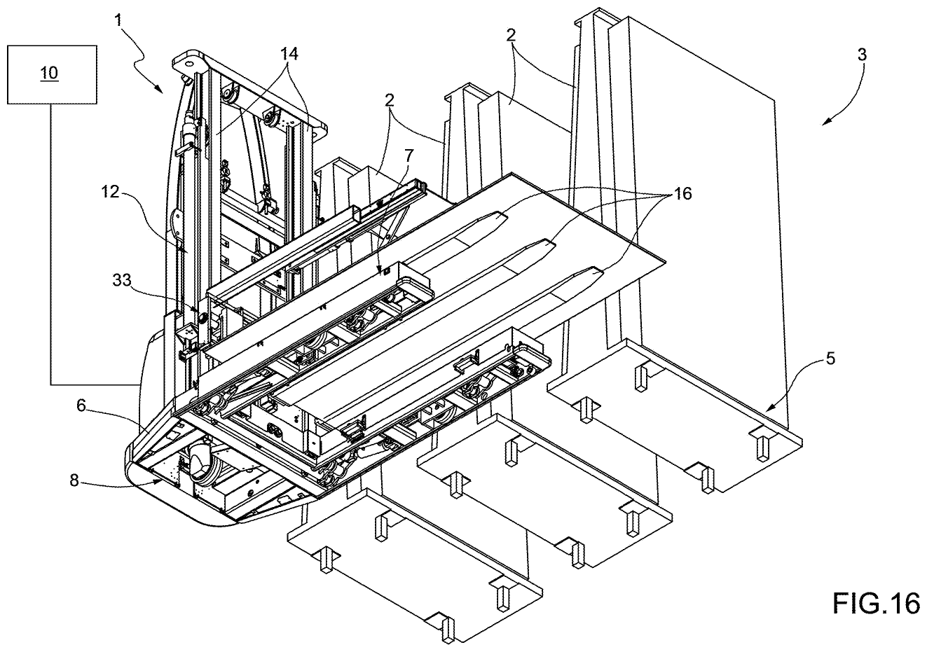

According to some advantageous but non-limiting embodiments, the support device 7 comprises (in particular, consists of) a plurality of forks 16 (see for example FIG. 16).

According to some advantageous but non-limiting embodiments such as the ones illustrated in FIGS. from 3 to 13, the support device 7 comprises a preferably box-shaped containing element 17, i.e. a container, provided with at least one upper opening (entry) 18. Specifically, according to some embodiments such as the ones illustrated in FIGS. from 1 to 13, the containing element 17 is arranged resting on the plurality of forks 16.

Advantageously but not necessarily, the moving assembly 12 is configured to move (at least) one of either the holding device 11 or the support device 7 so that the moving trajectory comprises an approaching segment, along which the holding device 11 and the support device 7 get close to one another in such a way that the holding device 11 is at least partially arranged in the containing element 17, in particular the moving trajectory extends through the upper opening 18.

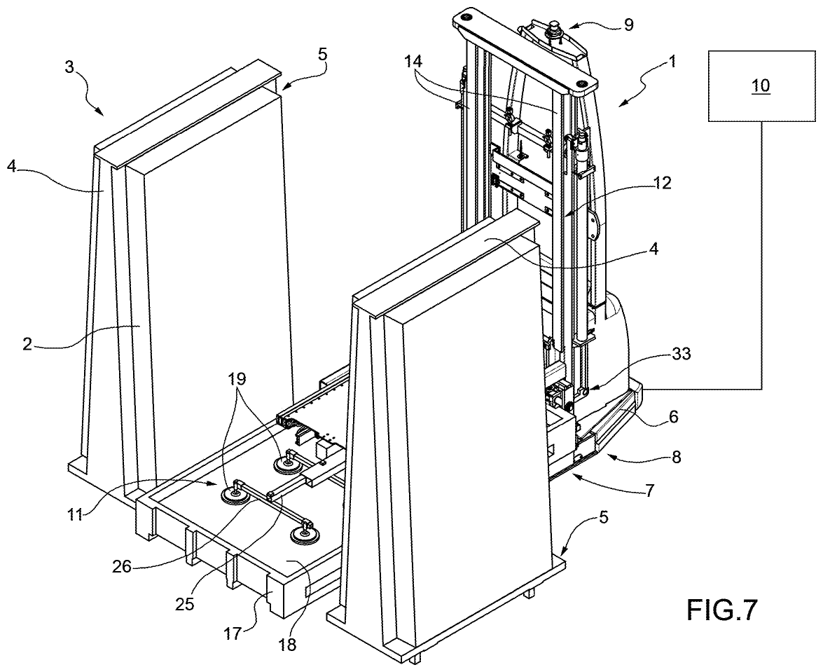

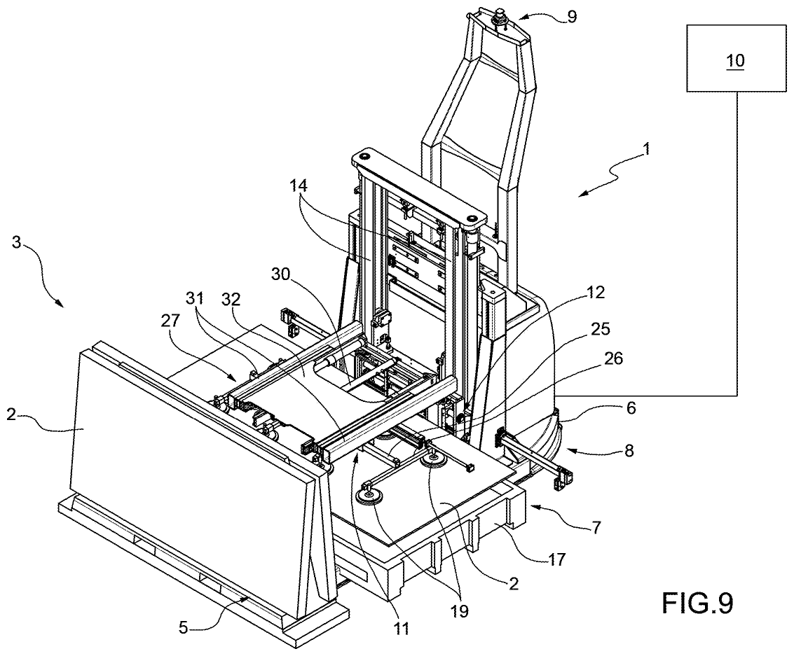

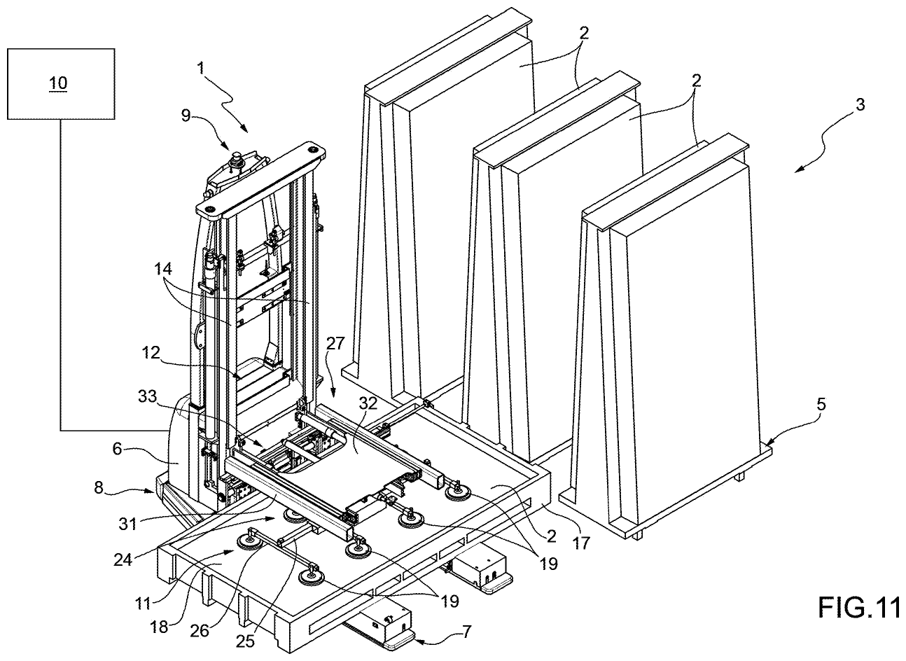

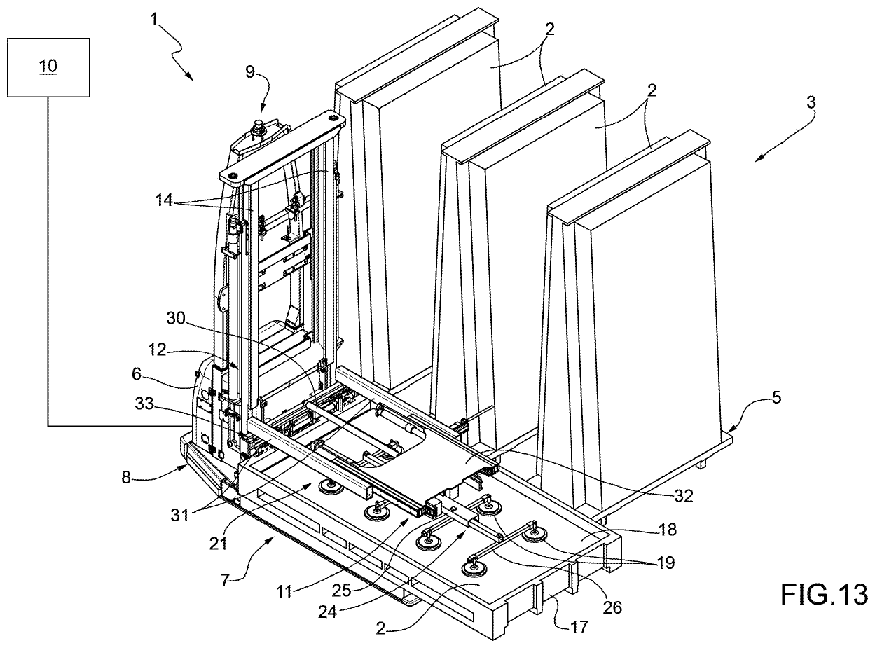

In particular, in this manner, in use, the holding device 11 enters the containing element 17 after (or before) picking up the flat ceramic article 2, for releasing (or holding) such flat ceramic article 2 in the containing element 17 (see for example FIGS. 7, 9, 11 and 13).

According to further non-limiting embodiments such as the ones illustrated in FIGS. from 14 to 16, the support device 7 comprises a containing element 17 in the form of a metallic tray.

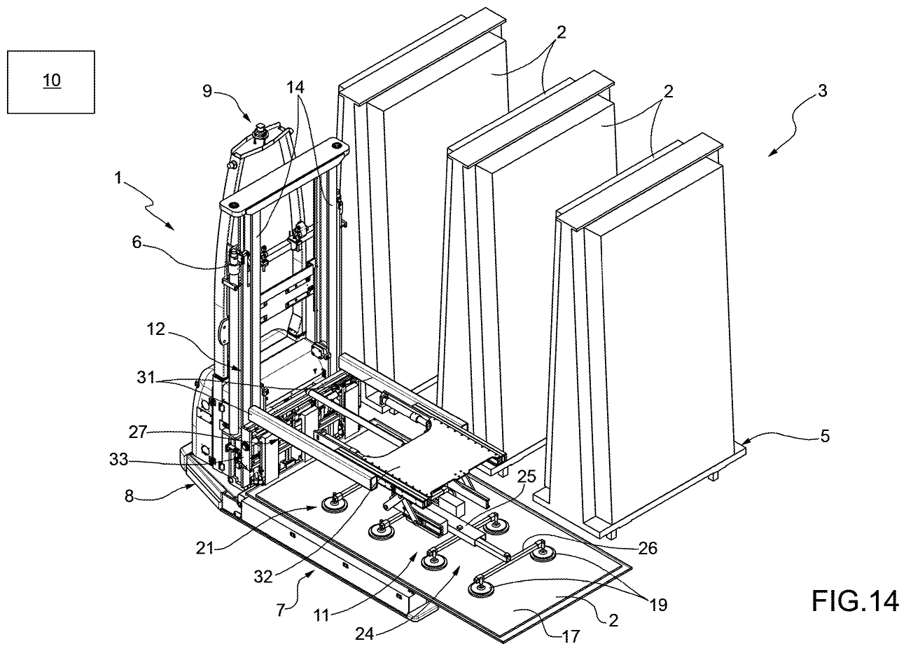

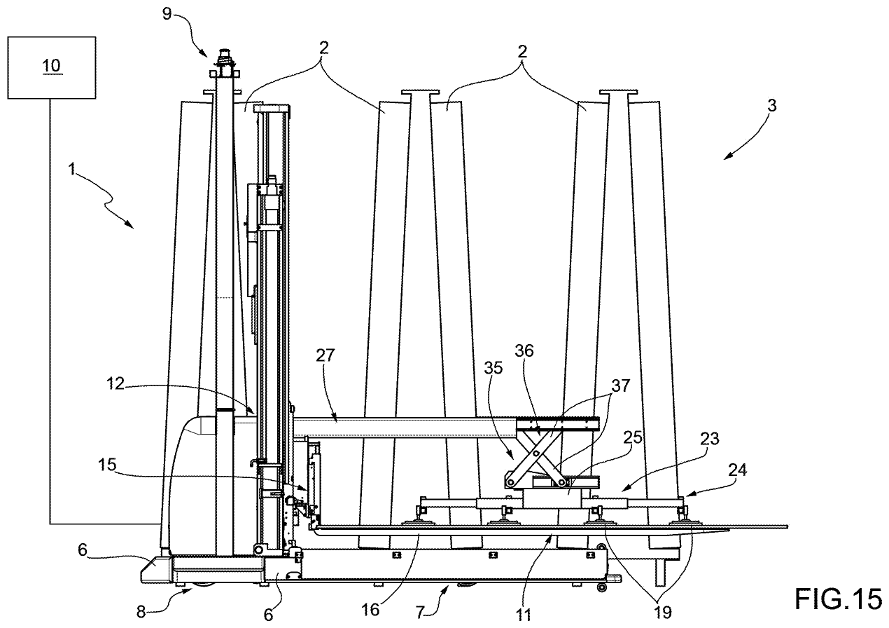

Advantageously but not necessarily, in this case, the moving trajectory, along which the holding device 11 and the support device 7 move, comprises at least one approaching segment, along which the holding device 11 and the support device 7 get close to one another in such a way that the holding device 11 is arranged at (in particular right above) the metallic tray (see for example FIG. 15), in order to allow the holding device 11 to release (or pick up) the flat article 2 resting on the metallic tray (see for example FIGS. 14 and 15).

According to further embodiments not illustrated, the support device 7 is configured to receive the group of articles 2 to be sent, without needing further containing devices. In this case, for example, the group of articles 2 to be sent is released by the holding device 11 directly onto the plurality of forks 16, which advantageously but not necessarily are also at least vertically movable, in particular along a moving trajectory, similar to the one described above for the containing device 17 so as to get close or move away relative to the holding device 11.

According to some advantageous but non-limiting embodiments, the holding device 11 comprises at least one suction head 19 for holding at least one flat article 2 exerting a given suction force. According to some embodiments such as the ones illustrated in the accompanying figures, the suction head 19 comprises (in particular, is) a suction cup.

Such suction head 19 is further, advantageously but not limitingly, configured to overlap in contact with at least part of the flat article 2 and pick it up or release it by means of suction.

Advantageously, this allows picking up (by grabbing/holding onto) the flat article 2 from an upper surface of the flat article 2, managing in this manner to pick up also flat articles 2, in particular flat ceramic slabs, of large dimensions and relatively small thickness (such as for example the ceramic slabs measuring 1200×2400 cm, or 1600×3200 cm; or 1800×3600 cm) without risking to excessively inflect them, and possibly damage them.

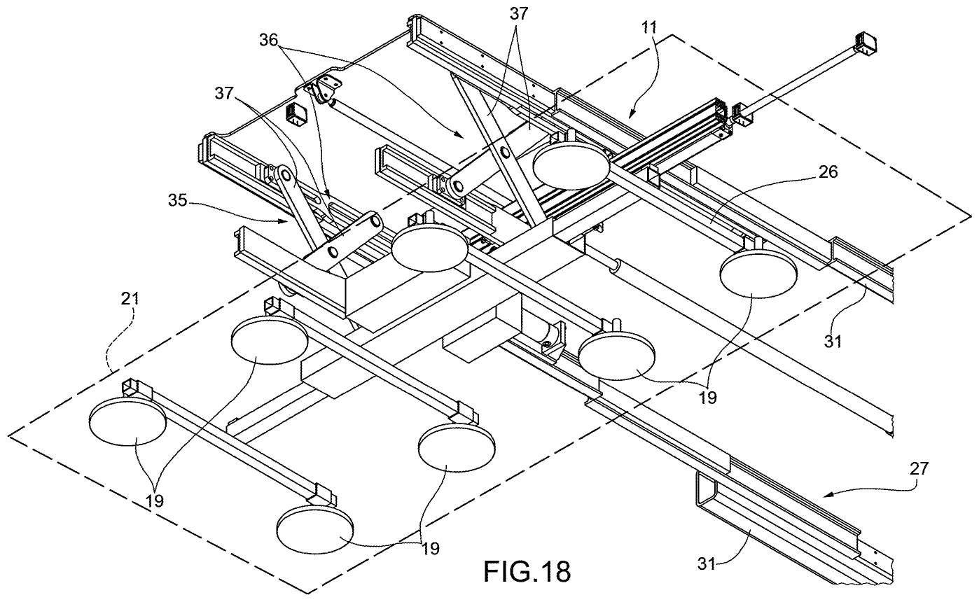

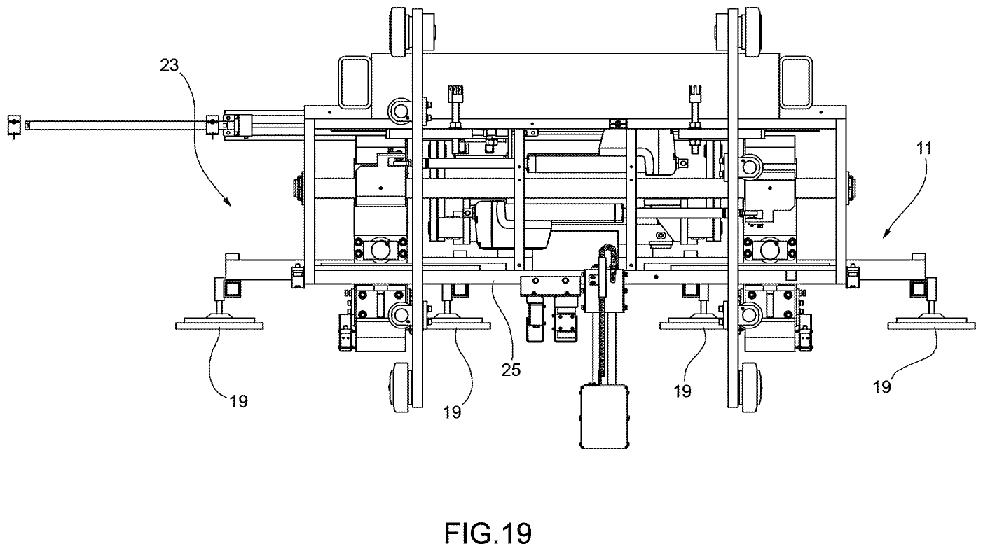

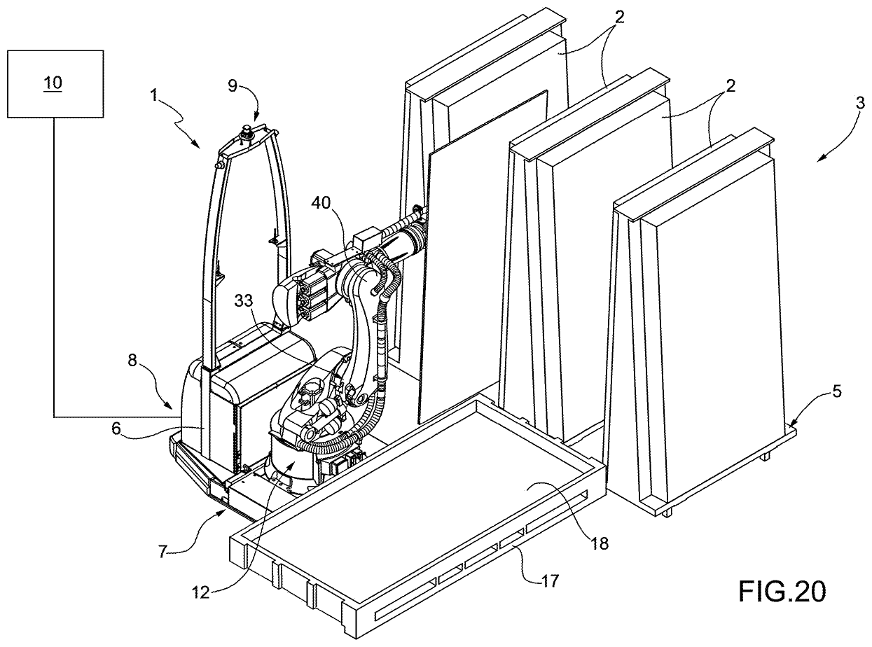

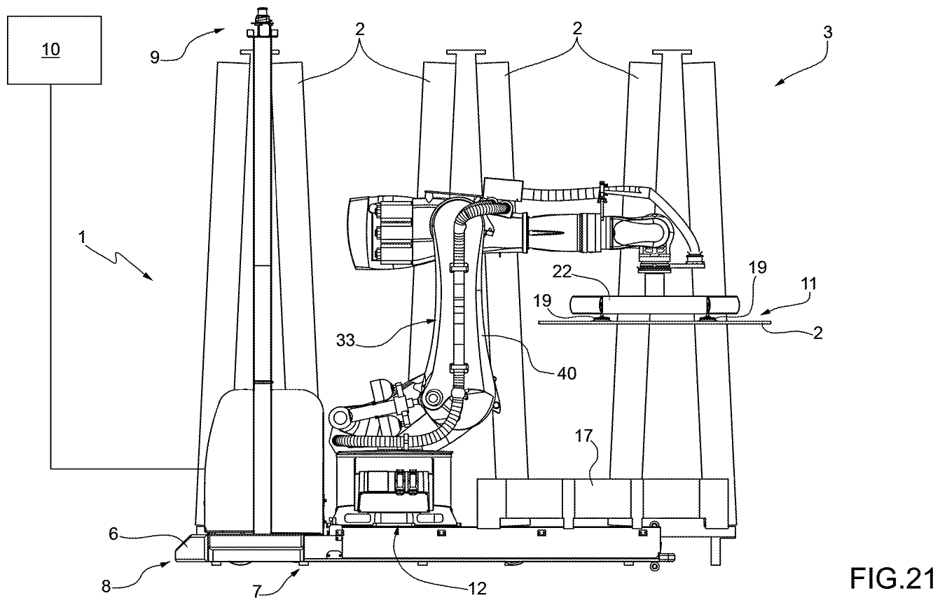

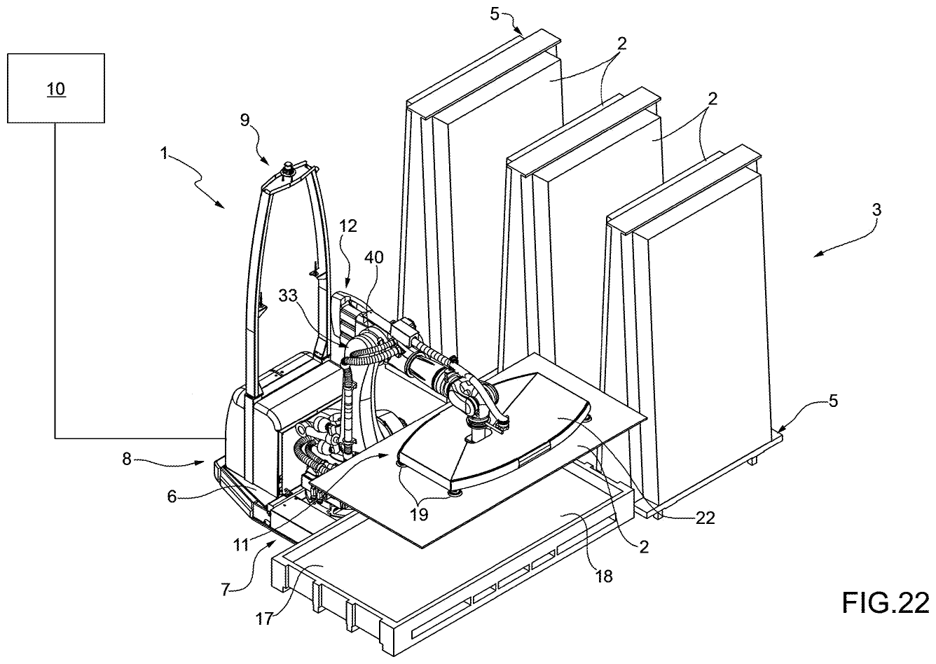

Specifically, according to the advantageous embodiments, the holding device 11 comprises at least one second suction head 19, even more in particular a plurality of suction heads 19, advantageously but not limitingly analogous to one another. Advantageously but not limitingly, such two or more suction heads 19 are arranged (and remain) on a same holding plane 21 (schematically indicated by a broken line in FIG. 18), i.e. are arranged (and remain) aligned at a same height between one another so as to define a holding plane 21, even more in particular such suction heads 19 are arranged in such a way that the suction mouth of each of such suction heads 19 lies on the same holding plane 21. Such arrangement of the suction heads 19 reduces (even more) the risk of damaging the flat article 2, for example the flat ceramic slab, when picking it up.

According to some advantageous but non-limiting embodiments such as the ones illustrated in FIGS. from 20 to 22, such suction heads 19 are carried by a support 22, in particular protruding from the support 22 along a direction perpendicular to the support 22, arranged between one another at a certain mutual distance. Specifically, advantageously, the support 22 is configured (i.e. is sized) and the suction heads 19 are arranged between one another and relative to the support 22 so as to allow the picking up of flat articles 2 of different format, i.e. shape and size. Specifically, according to some advantageous but non-limiting embodiments, the suction heads 19 are operable independently of one another so that upon the varying of the size of the flat article 2 to be picked up it is possible to deactivate some (for example, the more external ones) suction heads 19 of the holding device 11. In this case, for example, the support 22 can be sized so as to allow picking up the flat articles 2 of greater sizes (for example, of ceramic slabs of large formats) safely (reducing the risk of damage) and in the case of picking up flat articles 2 of smaller sizes, it will be sufficient to deactivate some (for example the more external ones) suction heads 19 of the holding device 11.

According to other advantageous but non-limiting embodiments (for example as illustrated in FIGS. from 1 to 19), the holding device 11 comprises at least one moving unit 23 for moving, i.e. getting close to and moving away from one another, at least the two or more suction heads 19 (in particular, always keeping them on the same plane). More precisely but not necessarily, the moving unit 23 is configured to move at least one of either the (two or more) suction heads 19 so that such suction heads 19 remain on the same holding plane 21. This allows, advantageously, adapting the size of the holding plane 21 to the format (shape and size) of the flat article 2 to be picked up, reducing the size of the areas that remain cantilevered relative to such holding plane 21 and thus reducing the risk of damaging the flat article 2.

Specifically, according to some advantageous but non-limiting embodiments such as the ones illustrated in FIGS. from 1 to 19, the moving unit 23 comprises a level structure 24, said level structure 24 carrying the suction heads 19 and which can be extended or shortened (for example operated by a suitable actuator or manually, as in the illustrated embodiments) in such a way that the shortening or the extension of the level structure 24 causes the suction heads 19 to get close to or move away from one another and thus the increase or the decrease in the size of the holding plane 21. In particular, according to some advantageous but non-limiting embodiments (see for example FIGS. from 1 to 19), the suction heads 19 are mounted on the level structure 24 and the level structure 24 comprises (see in particular FIG. 18) a main rod 25 which can be extended/shortened, advantageously but not limitingly of the telescopic type, and a plurality of secondary rods 26, said secondary rods 26 are arranged orthogonal to the main rod 25 and are fixed along the main rod 25 so that the extension or the shortening of the main rod 25 causes at least part of the secondary rods 26 to get close to or move away from one another. Advantageously, such secondary rods 26 carry, each, a suction head 19 fixed to a first endpoint of each secondary rod 26 and a suction head 19 fixed to a second endpoint, opposite the first endpoint, of each secondary rod 26, so that the shortening or the extension of the main rod 25 causes a variation of the size of the holding plane 21 at least in the direction of development of the main rod.

According to other embodiments not illustrated, (also) the secondary rods 26 comprise (in particular, are) rods which can be extended/shortened, advantageously but not limitingly of the telescopic type, this advantageously allows modifying the size of the holding plane 21 also along the direction of development of such secondary rods 26 (i.e. along the direction transverse to the direction of development of the main rod 25).

Alternatively, according to other advantageous but non-limiting embodiments not illustrated, the level structure 24 comprises a plurality of main rods 25 which can be extended/shortened and a plurality of secondary rods 26 arranged orthogonal to the main rods 25 and which can also be extended/shortened, advantageously but not limitingly of the telescopic type, and the suction heads 19 are fixed to the main rods 25 and to the secondary rods 26 in such a way that the extension or the shortening of such main rods 25 or secondary rods 26 causes the suction heads 19 to get close or move away, thus a variation of the size of the holding plane 21.

In some cases, the extension of the level structure 24 (and thus of its telescopic rods) is manually adjustable; advantageously but not necessarily, the extension of the level structure 24 (and thus of its telescopic rods) is modified by means of one or more electric or fluodynamic actuators.

It is understood that the holding device 11 could consist of one or more lifting clamps, of one or more finger grippers or in general of any holding member.

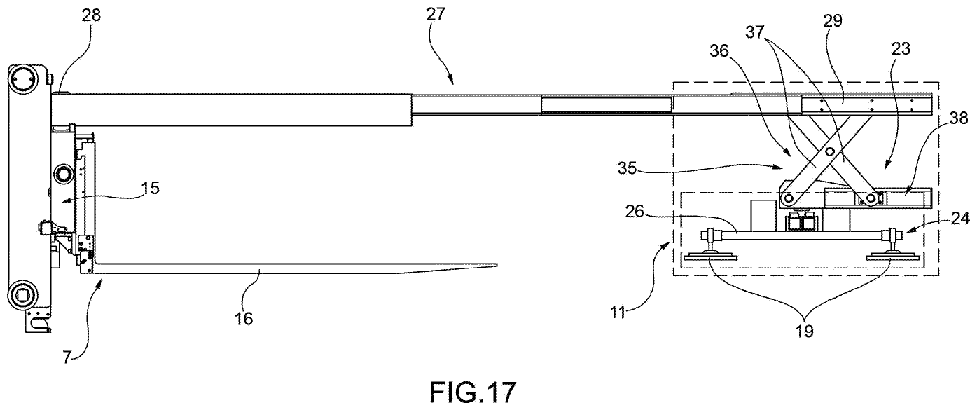

According to some advantageous but non-limiting embodiments such as the ones illustrated in FIGS. from 1 to 19, the moving assembly 12 comprises an extendable arm 27, which is connected at a first end 28 thereof to the frame 6, and at a second end 29 thereof, opposite to the first end 28, to the holding device 11 (see in particular FIG. 17). Advantageously but not necessarily, the extendable arm 27 is a telescopic arm and the moving assembly 12 comprises at least one actuator 30, for extending and shortening the extendable arm 27.

According to some advantageous but non-limiting embodiments such as the ones illustrated in FIGS. from 1 to 19, the extendable arm 27 comprises two telescopic rods 31 connected at their first end 28 to the frame 6, and a support portion 32 which is configured to support the holding device 11 and is fixed to the second end 29, opposite the first end 28, of the telescopic rods 31.

Specifically, according to some advantageous but non-limiting embodiments such as the ones illustrated in the accompanying figures, the moving assembly 12 comprises a moving device 33 for moving the extendable arm, and thus the holding device, relative to (along) the frame 6 at least partially vertically, i.e. either substantially vertically (as in the non-limiting embodiments illustrated in FIGS. from 1 to 19) or along an oblique trajectory having at least one vertical component. Advantageously, this allows raising the holding device 11 so as to be able to grab flat articles 2 from housings 5 arranged at any height.

According to some embodiments such as the ones illustrated in FIGS. from 1 to 16, the moving device 33 comprises an actuator (not visible in the accompanying figures) for moving the extendable arm 27 along the pair of vertical guides 14 (along which also the support device 7 moves). It is understood that such moving device 33 could be any other moving device which allows lowering or raising the extendable arm 27, and thus the holding device 11, relative to the frame 6.

According to some advantageous but non-limiting embodiments (FIGS. from 1 to 19), the moving assembly 12 comprises a further moving device 35 for at least partially vertically moving the holding device 11 (i.e. along a trajectory that has at least one vertical component) relative to the extendable arm 27. Specifically, according to some advantageous but non-limiting embodiments (see FIGS. from 1 to 19), the moving device 35 comprises an articulated kinematic mechanism 36, advantageously comprising (in particular, consisting of) two rods 37 arranged forming an “X” and articulated, i.e. hinged, to one another, in the centre and each having an endpoint articulated (i.e. hinged) to the extendable arm 27 and another endpoint articulated (i.e. hinged) to the holding device 11 (see in particular FIG. 17) so that the mutual moving of such rods 37 causes the holding device 11 to get close to or move away from the extendable arm 27. Advantageously but not necessarily, the moving device 35 also and at least comprises one actuator 30 for moving the articulated kinematic mechanism 36 so as to cause the holding device 11 to get close to or move away from the extendable arm 27.

Advantageously, the presence of such articulated kinematic mechanism 36 allows easily inserting the holding device 11 inside a housing 5 of a support structure 4, for example between a container contained in the housing 5 and the shelf that delimits the housing 5 at the top, moving the articulated kinematic mechanism 36 so as to cause the holding device 11 to get the closest possible to the extendable arm 27 (reducing to the minimum the vertical bulk of the holding device 11 and of the extendable arm 27 in order to be able to get into the space remaining between the container and the upper shelf) to then possibly move the articulated kinematic mechanism 36 again so as to move the holding device 11 away from the extendable arm 27, for example in order to allow the holding device 11 to enter inside the container and pick up one or more flat articles 2 from the container.

According to some advantageous but non-limiting embodiments (FIGS. from 1 to 19), the holding device 11 is arranged under the extendable arm 27, in particular is fixed at the bottom to the extendable arm 27 by means of interposition of the articulated kinematic mechanism 36.

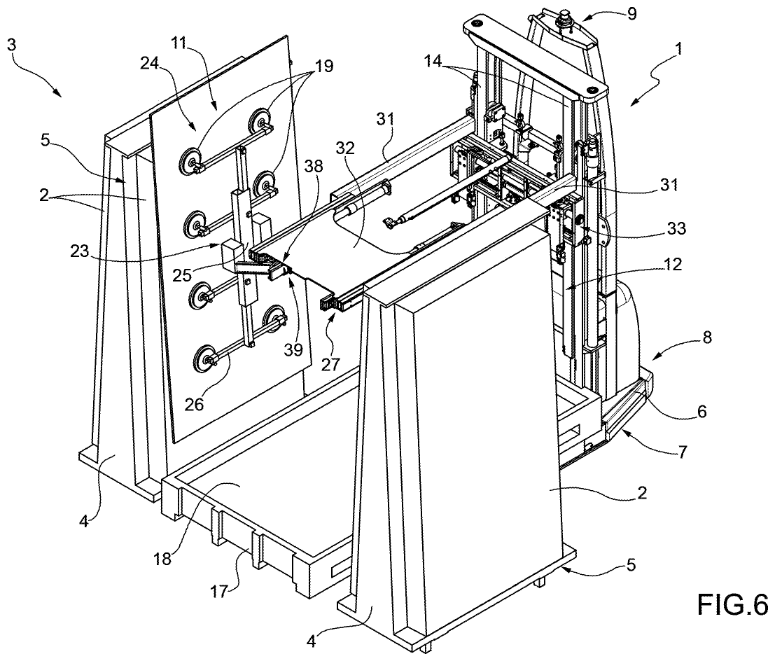

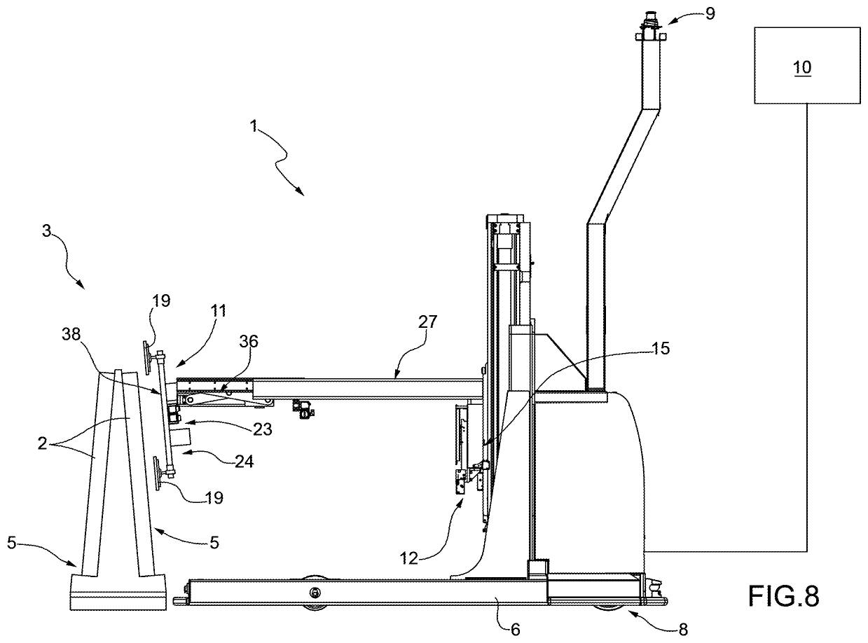

According to other non-limiting embodiments (FIGS. from 6 to 16), the moving assembly 12 also comprises a rotation device 38 for at least partially rotating the holding device 11, in particular the holding plane 21, relative to the frame 6 around an at least partially horizontal axis, in particular substantially horizontal (see for example FIGS. 6 and 8).

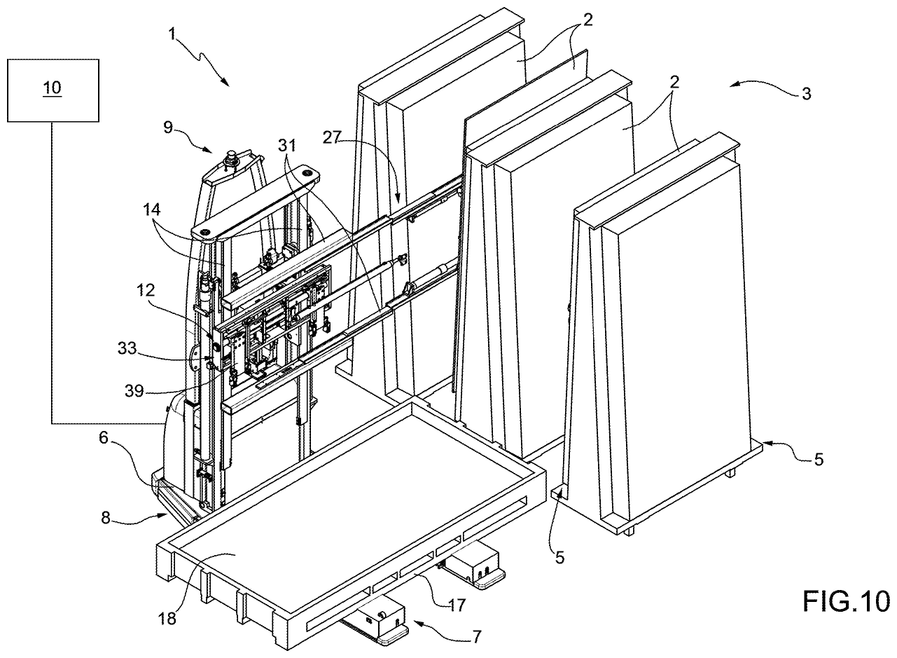

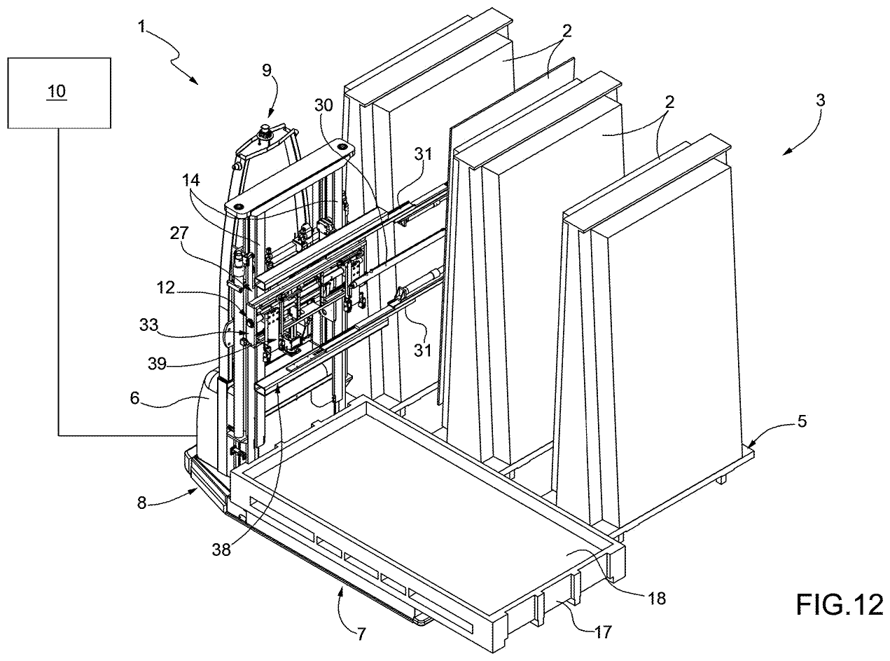

According to other embodiments such as, for example, the ones illustrated in FIGS. 10, 11, 12 and 13 the moving assembly 12 comprises at least one further rotation device 39 for rotating the holding device 11, in particular the holding plane 21, around a further at least partially vertical (in particular—according to what illustrated in the accompanying figures—substantially vertical) or at least partially horizontal axis (but different from the rotation axis around which the rotation is induced by the rotation device 38).

Advantageously, this allows the holding device 11 to pick up flat articles 2 from storing structures 4, in particular from housings 5, having any orientation relative to the frame 6 and, simultaneously, to release the picked up flat articles 2, possibly after rotating them, on the support device 7, in particular (as in the accompanying figures) onto the containing element 17, oriented in any manner relative to the frame 6.

According to other non-limiting embodiments (FIGS. from 20 to 22), the moving assembly 12 comprises (in place of the extendable arm 27) a robotic arm 40, which is connected at a first end thereof to the frame 6, and at a second end thereof, opposite to the first end, to the holding device 11. Advantageously but not necessarily, such robotic arm 40 is configured to at least partially vertically move the holding device 11 relative to the frame 6; in particular (also) at least partially horizontally relative to the frame 6.

More precisely but not necessarily, the robotic arm 40 can be moved so as to pick up a flat article 2 arranged according to any orientation relative to the vehicle 1, in particular relative to the frame 6, for example arranged on lateral stands as illustrated in FIGS. from 20 to 22, and so as to release such flat article 2 onto the support device 7 in a relatively short time (as illustrated in FIGS. from 20 to 22).

In accordance with a further aspect of the present invention, a method for handling flat articles 2 is also provided, advantageously but not necessarily implemented by means of the system 3 for the handling of flat articles 2 described above.

Advantageously but not necessarily, the method comprises: a first holding step, during which a holding device 11 of (belonging to) a vehicle 1, advantageously but not necessarily of the type described above, picks up at least one first flat article 2 from a first housing 5 of a storing structure 4 (of any type) and releases it onto the support device 7 of the vehicle 1; at least one second holding step, during which the holding device 11 picks up at least one second flat article 2, advantageously but not necessarily of a different type (i.e. having different aesthetic and/or physical and/or functional characteristics) relative to the first flat article 2 from a second housing 5 of the storing structure 4, advantageously different from the first housing 5 (i.e. having a different collocation relative to the first housing 5), and releases it onto the support device 7 so as to create a group of flat articles 2 to be sent; and a transport step, during which the vehicle 1 transports the group of flat articles 2 to be sent to a picking area.

Advantageously but not necessarily, during the first holding step and/or the second holding step, the holding device 11 picks up two or more flat articles 2 respectively from the first housing 5 and from the second housing 5.

According to other advantageous embodiments, the method further comprises a first approaching step, which is at least partially prior to the first holding step and during which the holding device 11 and the support device 7 get close to one another and/or a second approaching step, which is at least partially prior to the second holding step and during which the holding device 11 and the support device 7 get close to one another. In other words, the method provides for the support device 7 and the holding device 11 to get close to one another prior (or simultaneously) to the holding step so as to reduce the path that the holding device 11 has to do for releasing the flat article 2 after picking it up.

Advantageously but not necessarily, the first holding step comprises a first placing sub-step, during which the vehicle 1 places itself at the first housing 5 from which to pick up the first flat article 2 and a first insertion step, during which the holding device 11 gets into the first housing 5, or possibly when present in the container arranged in the housing 5, which contains the flat articles 2 of a certain type, for picking up the first flat article 2. In particular, the first placing sub-step is (at least partially) prior to the first insertion step.

Analogously, advantageously (also) the second holding step comprises a second placing sub-step during which the vehicle 1 places itself at the second housing 5 from which to pick up the second flat article 2 and a second insertion step in which the holding device 11 gets into the first housing 5, or possibly when present in the container arranged in the housing 5, for picking up the first flat article 2. In particular, the second placing sub-step is (at least partially) prior to the second insertion step.

According to other embodiments, when the support device 7 comprises a box-shaped containing element 17 or a metallic tray (as, for example, in the accompanying figures), the method comprises a further approaching step, (immediately—i.e. without other intermediate steps) subsequent to the first holding step, during which the holding device 11 and/or still a further approaching step, (immediately—i.e. without other intermediate steps) subsequent to the second holding step, during which the holding device 11 and the support device 7 get close to one another so that the holding device 11 is arranged at least partially inside the containing element 17.

In particular (after the further approaching step), in such containing element 17 the picked up articles 2 are released, respectively, during the first holding step and the second holding step.

According to further embodiments, the method also comprises a sending step, which is subsequent to said transport step and during which the group of flat articles 2 to be sent (already formed) is transferred into the sending area, and when this provides for a plurality of sending structures, onto a sending structure before being sent.

It is understood that the steps of the method can be repeated any number of times, upon the varying of the number of articles 2 constituting the group to be sent and/or of the number of articles 2 of a certain type constituting the group of articles 2 to be sent.

The present invention has several advantages relative to the prior art. Among these, we mention the following.

The vehicle 1 for collecting and transporting flat articles 2, the system 3 and the method for handling flat articles 2 of the present invention allow decreasing the number of trips that each single vehicle 1 has to accomplish between the storing structure 4 and the picking area so as to form a group of flat articles 2 to be sent, allowing creating (assembling/grouping) the group of flat articles 2 to be sent directly on the vehicle 1 so that the only trip that has to be done by the vehicle 1 to the picking area is the one for bringing the already formed group of flat articles 2 to be sent. This allows remarkably reducing the number of vehicles 1 that are necessary for each system 3 for handling flat articles 2, or, the number of vehicles 1 being equal, increasing the number of orders to be sent which is made at the same time.

Generally, the present invention allows reducing the time, increasing the efficiency and simplifying the procedures.

The present invention further allows eliminating, or reducing the complexity of the operations that the operators or the vehicles or the robots that are in the picking areas of the traditional systems for handling flat articles 2 have to carry out, with remarkable advantages in terms of cost-effectiveness, of occupied space, and of complexity of the system 3. Furthermore, the handling system 3 and the handling method also become much simpler, providing for a single type of vehicle 1, thus it becomes much simpler to train the personnel in charge of handling the system 3 and the vehicle 1.

1-13. (canceled)

14. A vehicle to collect and transport flat articles of the ceramic processing industry such as, for example, ceramic slabs and/or tiles; the vehicle being configured to transport at least 500 kg; the vehicle comprising:
a frame having at least one support device, which is configured to receive a plurality of flat articles;
a first moving device, which is configured to move said vehicle;
the vehicle being characterized in that it comprises:
at least one holding device, which is configured to hold and release at least one flat article; and
a moving assembly to move at least one of either the holding device or said support device relative to the other one along at least one moving trajectory, which is at least partially vertical;
wherein the holding device comprises at least one first suction head to hold said at least one flat article, at least one second suction head, and at least one moving unit to move at least one of either the first suction head or the second suction head relative to the other suction head; the first suction head and the second suction head being arranged on a same holding plane; in particular, the moving unit is configured to move at least one of either the first suction head or the second suction head on the holding plane.

15. A vehicle according to claim 14, wherein:
said moving trajectory is at least partially horizontal;
in particular, said support device comprises a containing element, which is provided with at least one upper opening;
in particular, the moving assembly is configured to move at least one of either said holding device or said support device so that the moving trajectory comprises an approaching segment, along which the holding device and the support device get close to one another in such a way that the holding device is at least partially arranged in the containing element.

16. A vehicle according to claim 14, wherein the moving assembly also comprises a fifth moving device to at least partially vertically move the support device.

17. A vehicle according to claim 14, wherein the moving assembly comprises:
an extendable arm, which is connected at an end thereof to said frame and to said holding device;
a second moving device to at least partially vertically move said extendable arm; and
at least one first actuator to extend and shorten said extendable arm; in particular, the extendable arm comprises a telescopic arm.

18. A vehicle according to claim 17, wherein the moving assembly comprises:
a third moving device to move the holding device relative to the extendable arm;
in particular, the holding device being arranged under the extendable arm;
in particular, the third moving device comprises an articulated kinematic mechanism.

19. A vehicle according to claim 14, wherein the moving assembly comprises:
a robotic arm, which is connected at an end thereof to said frame and to said holding device and is configured to at least partially vertically move the holding device; in particular, (also) at least partially horizontally.

20. A vehicle according to claim 14, wherein:
the moving assembly comprises a first rotation device to at least partially rotate the holding device relative to said frame around a first at least partially substantially horizontal axis;
in particular, the moving assembly comprises at least one second rotation device to rotate said holding device around a second at least partially vertical axis.

21. A vehicle according to claim 14, wherein:
the first moving device is configured to move said vehicle within a work area;
the vehicle further comprises a localization system, which is configured to localize and/or receive information on the position of said vehicle within said work area; and
a control unit, which is configured to operate said first moving device so as to move the vehicle within said work area based on what is detected and/or received by said localization system.

22. A system to handle flat articles comprising:
at least one storing structure comprising a plurality of housings, each accommodating, on the inside, a given type of flat articles;
a picking area to receive a group of flat articles to be sent;
a work area, which extends at least from said storing structure to said picking area;
at least one vehicle according to any one of the preceding claims, which is configured to operate within said work area so as to pick up a plurality of flat articles, each from a respective housing, and release them onto said support device in order to create said group of flat articles to be sent, and to bring said group of flat articles to be sent to said picking area.

23. A method to handle flat articles; the method comprises:
a first holding step, during which a holding device of a vehicle according to claim 14 picks up at least one first flat article from a first housing of a storing structure and releases it onto said support device;
at least one second holding step, during which said holding device picks up at least one second flat article from a second housing of said storing structure and releases it onto said support device so as to create said group of flat articles to be sent; and
a transport step, during which said vehicle transports said group of flat articles to be sent to a picking area.

24. A method according to claim 23 and comprising:
a first approaching step, which is at least partially prior to said first holding step and during which said holding device and the support device of said holding vehicle get close to one another; and
a second approaching step, which is at least partially prior to said second holding step, during which said holding device and the support device get close to one another.

25. A method according to claim 23 comprising:
a sending step, which is subsequent to said transport step and during which said group of flat articles to be sent is transferred onto a sending structure from said picking area.

26. A method according to claim 23, wherein:
said first holding step comprises:
a first placing sub-step, during which said at least one vehicle places itself at said first housing from which to pick up said first flat article, and
a first insertion step, during which said holding device gets into said first housing to pick up said first flat article; and
said at least one second holding step comprises:
a second placing sub-step, during which said at least one vehicle places itself at said second housing from which to pick up said second flat article, and
a second insertion step, during which said holding device gets into said first housing to pick up said first flat article.
